(19) United States
(12) Patent Application Publication
(10) Pub. No.: US 2006/0013944 A1
(43) Pub. Date: Jan. 19, 2006

(54) Developable phosphor coating mixture solution and method for manufacturing anodic phosphor layer

(75) Inventors: Shih-Chien Hsiao, Taipei (TW); Kuei-Wen Cheng, Taipei (TW); Jia-Hung Wu, Taipei (TW)

Correspondence Address: TROXELL LAW OFFICE PLLC;SUITE 1404, 5205 LEESBURG PIKE, FALLS CHURCH, VA, 22041, US

(73) Assignee: Teco Nanotech Co., Ltd.

(21) Appl. No.: 10/890,096

(22) Filed: Jul. 14, 2004

(51) Int. Cl. B05D 5/06; C09K 11/02

(52) U.S. Cl. 427/64; 427/157; 252/301.36

(57) ABSTRACT

A developable phosphor coating mixture solution and its manufacturing technique on anodic phosphor layers are described. The anodic phosphor layer of the field emission display is achieved through a silkscreen-printing method copulated with exposure procedure. The process is a simple silkscreen-printing method on an anodic glass substrate. Material features are combined with the manufacturing process to increase the adhesion ability of the phosphor powder on the anodic laminate. The exposure procedure develops high-resolution photography. The simple process and low cost coating can be used in manufacturing glass substrates.

### BACKGROUND OF THE INVENTION

1. Field of the Invention

The present invention relates to a manufacturing technique of a phosphor layer on an anodic laminate of a field emission display (FED), and particularly relates to a manufacturing technique of a patterned phosphor layer by means of a silkscreen-printing copulated with an exposure procedure.

2. Background of the Invention

Generally, field emission displays (FEDs) are display devices where electrons are liberated from an emitter on a cathode by quantum mechanical tunneling and impinge upon phosphors on an anode, thereby producing a predetermined screen image.

Referring to FIG. 1, a conventional FED 1a includes an anode 3a, a cathode 4a and a rib 53a arranged between the anode 3a and the cathode 4a for forming a vacuum space. As diagram 1 depicts, the anode 3a is constructed by an anodic glass substrate 31a, an anodic electric-conductive layer 32a and a phosphor layer 33a. The cathode 4a is constructed by a cathode glass substrate 41a, a cathode electric-conductive layer 42a and an electron emitter layer 43a. The anode 3a and the cathode 4a are separated from each other via the rib 53a for maintaining a vacuum space therebetween. Aided by an exterior electric field, the rib forces the electron emitter to release electrons, which then make the phosphor powder illuminate. The FED structure accepts 50 μm to 200 μm gaps between the anode 3a and the cathode 4a. The driving strength below 10 V/μm or the start voltage above 150 V will force the cathode 4a to release electrons. The luminescence efficiency relies on the selected phosphor powder.

Based on the above structures, micron gaps and the low start voltage all affect the luminescence efficiency. The structure of the anodic phosphor layer also influences the luminescence efficiency, influence factors including the uniform thickness of the phosphor layer and the internal structure of the phosphor layer. The uniform thickness of the phosphor layer relies on the even stacks of the ribs between the anode and the cathode laminates; therefore, the ribs of each relative electric field control the uniform luminescence and brightness of the excited phosphor powder. The internal structure refers to the distribution of the phosphor solution. Even if the start voltage of the two-electrode FED is above 150 V (volt), the voltage of high anodic three-electrode FED is mostly limited to below 5000 V, so the driving electron of this voltage has limited kinetic energy. As shown in FIG. 2, stack layers of phosphor solution should be limited. This excitation model refers to the first layer of phosphor powder 61a being excited by an electron beam 71a (however, excess electrons are reflected or bypassed 72a; whether the re-energy 72a of the first has enough power to excite the inter layer of phosphor powder 62a is still under discussion). The excitation model is different from the standard high voltage model (anode 23 KV) on CRT or on PDP, and also different from energetic plasma exciting phosphor powder. To summarize the traditional manufacturing techniques on phosphor layer 33a on the anode 3a: 1. A spin deposition coating process of CRT laminate to configure a phosphor layer, then an exposure procedure to get graphics. 2. A silkscreen-printing process directly prints the phosphor solution on the anode laminate to get graphics.

The spin deposition method has a uniform distribution thickness; however, due to a large flat glassy surface, when the machine vibration or dynamic drying process configures a thin film, a splinter down problem occurs. At the same time, a special treatment to increase adhesion strength of the phosphor layer on the laminate is another problem of this method. (The standard method evaporates an Al-film on the phosphor layer to increase the luminescence effectiveness and reduce the peel off of the phosphor layer. The evaporation method prohibits a low electric field and start voltage introduced in present invention.)

The silkscreen-printing provides a direct graphical printing method on the phosphor layer on a large surface, but this method uses over 100 Kcps high adhesive plasma with a particle diameter of around 4 μm, a coating concentration of between 8 μm to 15 μm, and a printing thickness of phosphor layer mostly between 12 μm to 16 μm with minimum 3 stacks of phosphor layers. A reduced diameter of phosphor solution does not decrease the thickness because of the printing process and the laminate structure. The interlocks of the printing-screen also prevent the uniform distribution of the coating. Gaps between gel and moirés set the minimum graphical wire to be over 80 μm. Reduce the thickness of the coating leads to pore space, which then causes uneven luminescence and shadows. As a result, the traditional methods have problems: 1. Providing a uniform coating method for even luminescence; 2. Coating mixture solution to produce precise resolution anode laminate through amber micro-developing method; 3. Providing simply and low cost implementation method to produce the anode phosphor coating layer of the FED. The present invention provides a technique that use silkscreen printing method copulates with exposure procedure possess the phosphor layer on the FED to overcome the mentioned issues. The present invention is: 1) a simple silkscreen-printing process on the anodic glass substrate; 2) includes a compounded supplemental solution to increase the adhesion strength between phosphor powder and the anode conductive layer; 3) uses an exposure procedure to produce high-resolution graphics; and 4) simplifies the process of coating manufactures glass substrates and is cheap.

### SUMMARY OF THE INVENTION

The present FED is an electric field that forces the cathode electron emitter to release electrons, which then incite the phosphor powder on the anodic laminate to illuminate. The FED is light, thin, and screen adjustable.

Conventionally, the traditional spin deposition of an anodic phosphor layer on FED is difficult for large glass substrates, while the silkscreen-printing method cannot produce high-resolution graphics. To overcome these issues, the present invention provides silkscreen-coating technique combined with an exposure procedure to process the phosphor layer on an FED, which has: 1. a simple silkscreen-printing technique used on the anodic glass substrate; 2. a compounded supplemental solution to increased the adhesion strength between phosphor powder and the anode conductive layer.; 3. an exposure procedure to provide high-resolution graphics; and 4. a simple and cheap process for glass substrates.

The major purpose of the present invention is to provide a developable phosphor coating mixture solution used on silkscreen-printing to produce coating, and then combine the same with an exposure procedure to process a graphical phosphor layer.

The other purpose of the present invention is to provide a developable phosphor coating mixture solution used on silkscreen-printing to produce high resolution graphic through an exposure procedure.

The third purpose of this invention is to provide a developable phosphor coating mixture solution used on silkscreen-printing to increase the adhesion strength through a suitable coagulator of the anodic glass.

The fourth purpose of the invention is to provide a developable phosphor powder used on silkscreen-printing to increase the conductive ability by adding electric-conductive powder according to the FED requirement on the low threshold voltage.

In view of the above-mentioned purposes, the present invention provides a printable and developable phosphor coating mixture solution through a printing method and an exposure procedure to process the anodic phosphor layer. The developable phosphor mixture solution is a high-viscosity, compound solution make from the developer (aqua-resin mixed with photoreaction initialize agent) mixed with phosphor mixture solution, coagulator, electric-conductive powder and a necessary dispersion agent (to provide uniform distribution of powder). The mixture is used for a printing procedure.

A printing procedure coats the phosphor mixture solution on the anodic glass substrate, and then the substrate is baked at a low temperature to configure a thin film. Photoreaction and chemical reaction are performed on graphical region through exposure to ultraviolet Hg-light (mercury). The exposure procedure peels off the blank spaces, and, finally, a drying process follow by a high temperature sintering process adhere the phosphor powder on the anodic glass substrate.

The present invention comprises a solvent, aqua-resin (dissolved in the solvent); a photoreaction initialization agent with a light-negative-resistance feature (dissolved in the solvent); phosphor powder (suspended in the solvent); and coagulator (to help the phosphor powder adhere on the anode structure after adhesion treatment). The viscosity of the compounded solution is set between 50000 to 200000 cps as required by silkscreen-printing.

The manufacturing procedures of present invention to produce anodic phosphor layer through a developable phosphor coating mixture solution consist of: 1) silkscreen-printing coats the developable phosphor coating mixture solution on the anode laminate; 2) preheating at a low temperature to configure a thin film; 3) exciting mercury (Hg) to produce ultraviolet light in order to perform photoreaction and chemical reaction on a required graphical region; 4) an exposure procedure, where water is treated as a developer since the solvent is aqua-resin; and 5) a drying process.

### BRIEF DESCRIPTION OF DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is schematic view showing a construction structure of a conventional FED; and

FIG. 2 is schematic view showing a conventional technique of phosphor layer.

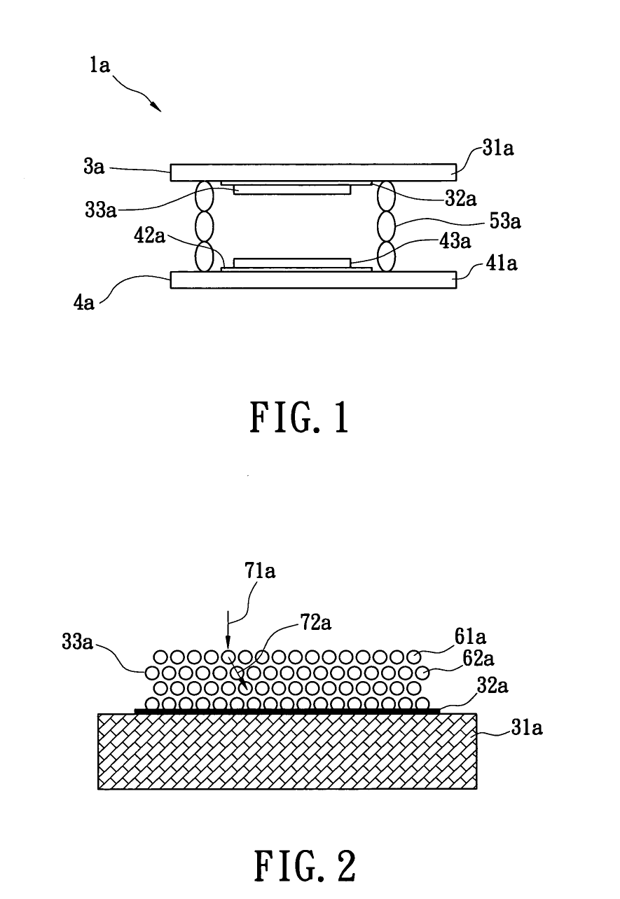

### DESCRIPTION OF THE PREFERRED EMBODIMENT

The present invention provides a printable developable phosphor coating mixture solution for manufacturing a phosphor layer by means of a printing and exposure procedures. The solution is an aqua-resin reacting with an additive photoreaction initialization agent such as dichromate to form a light-negative-resistance solvent. Solvent is then added to phosphor powder, adhesive powder, coagulator and additional conductive power to form a compound solution. The aqua-resin is, for example, aqua-polyvinyl alcohol; the adhesive powder is, for example, glass powder; the coagulator is, for example, silicon dioxide solution of [TEOS; and an additional conductive power is, for example, aluminum powder, indium oxide, or ITO (a semiconductor material, belongs to P-22 series) used to reduce the conductive resistance of the phosphor layer. The compound solution has a high viscosity of over 50000 cps for better usage in the printing process.

The implementation method comprises the following steps. An anodic glass substrate is coated with developable phosphor mixture solution through a printing technique, then preheated at a low temperature to configure a thin film. Mercury is excited to get ultraviolet light and form a graphical required light-mask in order to perform photoreaction and chemical reaction on a required graphical region. An exposure is performed; since aqua-resin is used, water is chosen as the developer due to its low cost and environmental protection features. The developed coating goes through a drying procedure and then a high temperature procedure adheres the phosphor powder on the glass substrate.

The present invention provides a manufacturing method on a printable developable phosphor coating mixture solution that uses printing process copulates with exposure procedure to produce a phosphor layer. Water is a basic solvent mixed with high polyester solvent such as 10-15% weight of polyvinyl alcohol, 1-5% weight of dichromate such as a photoreaction initialization agent to configure the light-resistance agent. A compound of these produces a basic light-negative-resistance material. The material is mixed with 35-45% weight of selected phosphor powder (the average diameter of selected particle is 1 μm to 5 μm), necessary coagulator or adhesive liquid (say 1-5% of glass powder or TEOS liquid), then combined with the sintering process for a better adhesion strength of phosphor powder. To reduce the impedance of phosphor layer, 8-15% weight of electric-conductive powder, aluminum powder, indium series or ITO is added. Additional dispersion agent or interfacial active agent can be added for a uniform distribution of the powder. The final viscosity of the compounded phosphor coating powder is in the range of 50 to 200 Kcps for better coating in the printing process.

The implementation method of the compound developable phosphor coating mixture solution of the present invention uses a printing process to render the solution on the anode phosphor glass substrate, and the printing laminate presets graphics for better coating effectiveness. The printing process configures a smooth, uniform layer. The layer is undergoes a simple baking procedure to configure a thin film and is maintained at a standard temperature to combine with the exposure procedure. The exposure procedure uses mercury to excite ultraviolet light with an irradiation of over 5000 lux. A designed cavity mask forces the exposure region to be maintained after development. Exposure for a time interval is the exposure procedure. The developer is water with a preset temperature, which then develops through metal spraying under some pressure. The tolerance error between persisted graphic on the phosphor layer after development and the designed graphic of the shadow-cavity mask is below 5 μm. The developed anode laminate can simply be baked to remove the residual developer on the anodic glass substrate. The developed anodic glass substrate is sintered at a high temperature to adhere the phosphor powder on the anode electrode.

Practical manufacturing procedures:

1. Mixture procedure, the coating comprising the basic solvent, and water mixed with various weights of additive solvents. These solvents comprise: 12% polyvinyl alcohol, 3% sodium dichromate, 40% phosphor mixture solution with average 1 μm particle diameter, 3% glass powder with particle diameter below 0.1 m, 10% aluminum powder as well as necessary dispersion or interfacial active solvent to supplement the dispersion of the particle powders.

2. The coating is rendered on the anodic glass substrate through the printing process to configure an average 4 μm to 6 μm coating layer and then sintered at 60 degrees Centigrade for 10 minutes before exposure to the 5000 lux irritation of the ultraviolet for 1 minute.

3. In the exposure procedure, deionized water works on 45 degrees Centigrade water temperature and 2 Kg/cm² water pressure to develop a graphic; the developed graphic on the positive laminate can achieve a 10 μm resolution, a 10 μm graphic interval may contain less than 0.1% coating residuals, a 50 μm graphic interval may contain non-residuals, the tolerance of the developed graphic is set to below 2.0 μm, which meets the commercial requirements, the process then goes to baking procedure, the developed positive glass substrate is baked at 100 degrees Centigrade for 10 minutes to peel off the residual developer, the process then goes to a high temperature sintering procedure, and the completed completion of this procedure is the completion of the developable coating of the present invention.

The described process is a detailed manufacturing procedure to produce the phosphor layer through printing process copulates with exposure procedure. The compound agents of the present invention consist of: solvent, aqua-resin (dissolved in the said solvent), photoreaction initialization agent with a light-negative resistance feature (dissolved in the solvent), phosphor powder (suspended in the solvent), and the necessary coagulator (aids the phosphor powder to adhere on the positive structure). The viscosity of the compounded developable phosphor coating mixture solution is set between 50000 to 200000 cps for the silkscreen-printing requirement.

The developable phosphor coating mixture solution of the present invention further comprises electric-conductive powder (to reduce the electric-impedance of the coating layer) and disperser (dissolved in the said solvent to disperse the powder or particles evenly). The electric-conductive powder is, for example, aluminum powder, indium series, or ITO powder; the coagulator is, for example, glass powder, nitro-cotton, or liquid TEOS; the solvent is, for example, water; the aqua-resin is, for example, polyvinyl alcohol; the photoreaction initialization agent is, for example, dichromate series; and the process of adhesion is, for example, a sintering process to configure anodic phosphor layer.

The manufacturing method of anodic phosphor layer of this invention includes: a) coating a developable phosphor coating mixture solution on an anode laminate by means of a silkscreen-printing manner to form a coating layer; b) preheating the coating mixture solution at a low temperature to form a thin film; c) providing an exposure step through an ultraviolet light generated from an excitation lamp and a patterned photo mask to process a photochemical transformation of the thin film; d) providing a developer, water, for development of the aqua-resin; and e) providing a drying process.

Various implementations of this invention are described as follows. A decomposition adhesion process on the coating layer of step 5 is to configure an anodic phosphor layer. The adhesion process can be a sintering process. The ultraviolet exposure process is for 0.5-3 minutes under ultraviolet light with a 4000-6000 lux irradiation. The low temperature preheat process can bake the coating layer at 40-80° C. for 5-20 min. The developing process can develops graphic in de-ionic water with a temperature of 45° C. and a 2 Kg/cm² water pressure. The drying process can bake at 90-110° C. for 5-20 minutes. Advantages of this invention are summarized below:

1. The manufacturing method on phosphor coating powder of this invention can easily be implemented through a printing method combined with a exposure procedure process. This invention provides a uniform distribution thickness with high-resolution anodic phosphor layers.

2. The developing process on phosphor layer of this invention can provide high-resolution graphical anode laminate.

3. The manufacturing method on electron emitter layer of this invention uses conventional coating materials, and the simple exposure procedure and environmental protection ability thereof are practical for the current commercial market.

Above is the optimal implementation of present invention; it will be apparent that various changes and modifications can be made without departing from the scope of the invention as defined in the claims.

What is claimed is:

1. A developable phosphor coating mixture solution for forming a coating layer on a silkscreen-printing anodic structure of electric equipment, comprising:
a solvent;
an aqua-resin dissolved in the solvent;
a light-negative-resistance photoreaction initialization agent dissolved in the solvent;
a phosphor powder suspended in the solvent; and
a coagulator for assisting the phosphor powder to adhere on the anode structure after an adhesion process;
wherein a viscosity of the compounded developable phosphor coating mixture solution is between about 50000 to 200000 cps for a silkscreen-printing requirement.

2. The developable phosphor coating mixture solution as according to claim 1, further comprising an electric-conductive powder used to reduce electric-impedance on the coating layer.

3. The developable phosphor coating mixture solution as according to claim 1, further comprising a disperser dissolvent spread in the solvent to disperse uniformly powder or micro-particle in the solvent.

4. The developable phosphor coating mixture solution as according to claim 1, wherein the coagulator is glass powder or nitro-cotton, the solvent is water, the aqua-resin is polyvinyl alcohol, and the photoreaction initialization agent is dichromate.

5. The developable phosphor coating mixture solution as according to claim 2, wherein the electric-conductive powder is aluminum powder, indium series or ITO powder.

6. The developable phosphor coating mixture solution as according to claim 1, wherein the adhesion process is a sintering process of forming an anodic phosphor layer.

7. A method for manufacturing an anodic phosphor layer by using the developable phosphor coating mixture solution as according to claim 1, comprising the steps of:
a) coating a developable phosphor coating mixture solution on an anode laminate by means of a silkscreen-printing manner to form a coating layer;
b) preheating the coating mixture solution at a low temperature to form a thin film;
c) providing an exposure step through a ultraviolet light generated from an excited lamp and a patterned photo mask to process a photochemical transformation of the thin film;
d) providing a developer, water, for development of the aqua-resin; and
e) providing a drying process.

8. The method according to claim 7, further comprising a predetermined adhesion process on the coating layer to configure an anodic phosphor layer.

9. The method according to claim 8, wherein the adhesion process is a sintering process.

10. The method according to claim 7, wherein the ultraviolet exposure process is substantially equal to exposures of about 0.5-3 minutes under ultraviolet light with an about 4000-6000 lux irradiation, the low temperature preheat process being substantially equal to preheating the coating layer at about 40-80 degrees Centigrade for about 5-20 min, the developing process being substantially equal to developing in deionized water at about 30-60 degrees Centigrade and 2 Kg/cm² water pressure to develop a graphic.

11. The method according to claim 7, wherein the drying process is substantially equal to sintering at about 90-110 degrees Centigrade for 5-20 minutes.
